(19) United States
(12) Patent Application Publication
(10) Pub. No.: US 2026/0089633 A1
(43) Pub. Date: Mar. 26, 2026

(54) TECHNIQUES FOR SINGLE FREQUENCY NETWORK TRANSMISSION

(71) Applicant: QUALCOMM Incorporated, San Diego, CA (US)

(72) Inventors: Huilin XU, Temecula, CA (US); Hung Dinh LY, San Diego, CA (US); Shijun WU, San Diego, CA (US)

(21) Appl. No.: 18/896,094

(22) Filed: Sep. 25, 2024

(51) Int. Cl. H04W 52/02; H04W 68/06

(52) U.S. Cl. CPC H04W 52/0235; H04W 68/06

(57) ABSTRACT

Various aspects of the present disclosure generally relate to wireless communication. In some aspects, a user equipment (UE) may receive, using a first transmit/receive (Tx/Rx) chain, a low-power wake-up signal (LP-WUS) communication, wherein the LP-WUS communication is conveyed via a set of single frequency network (SFN)-type transmissions from a set of transmitters associated with a set of cells. The UE may communicate, using a second Tx/Rx chain, in one or more resources in connection with the LP-WUS. Numerous other aspects are described.

### FIELD OF THE DISCLOSURE

Aspects of the present disclosure generally relate to wireless communication and specifically relate to techniques, apparatuses, and methods associated with single frequency network transmission.

### DESCRIPTION OF RELATED ART

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a method of wireless communication performed by a user equipment (UE). The method may include receiving, using a first transmit/receive (Tx/Rx) chain, a low-power wake-up signal (LP-WUS) communication, wherein the LP-WUS communication is conveyed via a set of single frequency network (SFN)-type transmissions from a set of transmitters associated with a set of cells. The method may include communicating, using a second Tx/Rx chain, in one or more resources in connection with the LP-WUS.

Some aspects described herein relate to a method of wireless communication performed by a network node. The method may include transmitting a transmission of an LP-WUS communication, wherein the transmission of the LP-WUS communication is conveyed via a SFN-type transmission, of a set of SFN-type transmissions, and wherein the transmission of the LP-WUS is coordinated with a set of transmitters associated with a set of cells. The method may include communicating in one or more resources in connection with the LP-WUS.

Some aspects described herein relate to a method of wireless communication performed by a core node. The method may include identifying a configuration for a set of cells for transmission of an LP-WUS communication, wherein transmission of the LP-WUS communication is conveyed via a set of SFN-type transmissions from a set of transmitters and in a set of cells. The method may include sending, to a set of network nodes associated with the set of transmitters, information identifying the configuration to cause the transmission of the LP-WUS communication via the set of SFN-type transmissions in the set of cells.

Some aspects described herein relate to a UE for wireless communication. The user equipment may include one or more memories and one or more processors coupled to the one or more memories. The one or more processors may be configured to receive, using a first Tx/Rx chain, an LP-WUS communication, wherein the LP-WUS communication is conveyed via a set of SFN-type transmissions from a set of transmitters associated with a set of cells. The one or more processors may be configured to communicate, using a second Tx/Rx chain, in one or more resources in connection with the LP-WUS.

Some aspects described herein relate to a network node for wireless communication. The network node may include one or more memories and one or more processors coupled to the one or more memories. The one or more processors may be configured to transmit a transmission of an LP-WUS communication, wherein the transmission of the LP-WUS communication is conveyed via a SFN-type transmission, of a set of SFN-type transmissions, and wherein the transmission of the LP-WUS is coordinated with a set of transmitters associated with a set of cells. The one or more processors may be configured to communicate in one or more resources in connection with the LP-WUS.

Some aspects described herein relate to a core node for wireless communication. The core node may include one or more memories and one or more processors coupled to the one or more memories. The one or more processors may be configured to identify a configuration for a set of cells for transmission of an LP-WUS communication, wherein transmission of the LP-WUS communication is conveyed via a set of SFN-type transmissions from a set of transmitters and in a set of cells. The one or more processors may be configured to send, to a set of network nodes associated with the set of transmitters, information identifying the configuration to cause the transmission of the LP-WUS communication via the set of SFN-type transmissions in the set of cells.

Some aspects described herein relate to a non-transitory computer-readable medium that stores a set of instructions for wireless communication by a UE. The set of instructions, when executed by one or more processors of the UE, may cause the UE to receive, using a first Tx/Rx chain, an LP-WUS communication, wherein the LP-WUS communication is conveyed via a set of SFN-type transmissions from a set of transmitters associated with a set of cells. The set of instructions, when executed by one or more processors of the UE, may cause the UE to communicate, using a second Tx/Rx chain, in one or more resources in connection with the LP-WUS.

Some aspects described herein relate to a non-transitory computer-readable medium that stores a set of instructions for wireless communication by a network node. The set of instructions, when executed by one or more processors of the network node, may cause the network node to transmit a transmission of an LP-WUS communication, wherein the transmission of the LP-WUS communication is conveyed via a SFN-type transmission, of a set of SFN-type transmissions, and wherein the transmission of the LP-WUS is coordinated with a set of transmitters associated with a set of cells. The set of instructions, when executed by one or more processors of the network node, may cause the network node to communicate in one or more resources in connection with the LP-WUS.

Some aspects described herein relate to a non-transitory computer-readable medium that stores a set of instructions for wireless communication by a core node. The set of instructions, when executed by one or more processors of the core node, may cause the core node to identify a configuration for a set of cells for transmission of an LP-WUS communication, wherein transmission of the LP-WUS communication is conveyed via a set of SFN-type transmissions from a set of transmitters and in a set of cells. The set of instructions, when executed by one or more processors of the core node, may cause the core node to send, to a set of network nodes associated with the set of transmitters, information identifying the configuration to cause the transmission of the LP-WUS communication via the set of SFN-type transmissions in the set of cells.

Some aspects described herein relate to an apparatus for wireless communication. The apparatus may include means for receiving, using a first Tx/Rx chain, an LP-WUS communication, wherein the LP-WUS communication is conveyed via a set of SFN-type transmissions from a set of transmitters associated with a set of cells. The apparatus may include means for communicating, using a second Tx/Rx chain, in one or more resources in connection with the LP-WUS.

Some aspects described herein relate to an apparatus for wireless communication. The apparatus may include means for transmitting a transmission of an LP-WUS communication, wherein the transmission of the LP-WUS communication is conveyed via a SFN-type transmission, of a set of SFN-type transmissions, and wherein the transmission of the LP-WUS is coordinated with a set of transmitters associated with a set of cells. The apparatus may include means for communicating in one or more resources in connection with the LP-WUS.

Some aspects described herein relate to an apparatus for wireless communication. The apparatus may include means for identifying a configuration for a set of cells for transmission of an LP-WUS communication, wherein transmission of the LP-WUS communication is conveyed via a set of SFN-type transmissions from a set of transmitters and in a set of cells. The apparatus may include means for sending, to a set of network nodes associated with the set of transmitters, information identifying the configuration to cause the transmission of the LP-WUS communication via the set of SFN-type transmissions in the set of cells.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of a low power wake-up radio and a low power wake-up signal, in accordance with the present disclosure.

FIG. 4 is a diagram illustrating an example associated with single frequency network (SFN) communication, in accordance with the present disclosure.

FIGS. 5A-5B are diagrams illustrating an example associated with SFN transmission, in accordance with the present disclosure.

FIG. 6 is a diagram illustrating an example process performed, for example, at a UE or an apparatus of a UE, in accordance with the present disclosure.

FIG. 7 is a diagram illustrating an example process performed, for example, at a network node or an apparatus of a network node, in accordance with the present disclosure.

FIG. 8 is a diagram illustrating an example process performed, for example, at a core node or an apparatus of a core node, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A wireless communication system may provide for communications between network nodes and a user equipment (UE). These communications may consume some amount of power. For example, a UE may consume a lower amount of power while in a low power state (such as while not connected to a network or while waiting for paging from the network), and may consume a higher amount of power while in a full power state (such as while actively communicating with a network node or while monitoring for control information from the network). Certain components of the UE may consume a significant amount of power. For example, a radio of the UE, which may support bidirectional communication (such as both transmission and reception), multi-layer communication, or larger bandwidths (such as a communication bandwidth of the UE), may consume power while active, such as in the course of communicating or monitoring for control information.

Some techniques provide power savings at the UE by limiting the amount or ratio of time in which a radio is active, relative to the amount of time in which the radio is inactive or powered down. For example, a connected mode discontinuous reception (C-DRX) cycle may provide off durations (sometimes referred to as inactive times or sleep durations) in which the radio is inactive, and on durations (sometimes referred to as active times or wake durations) in which the radio is active. The UE may monitor for a physical downlink control channel (PDCCH) (or another control channel or data channel) during an on duration, and may extend the on duration if a PDCCH communication is received, which facilitates further communication in accordance with the PDCCH communication. Thus, power consumption of the main radio may be reduced by reducing the amount of time in which the main radio is active and/or monitoring for a PDCCH communication.

While the C-DRX cycle reduces power consumption at the UE and the network, further power savings may be desirable, particularly in 5G, 6G, and similar radio access technologies (RATs) where beamforming and high-frequency communication cause increased power consumption relative to other RATs. To achieve further power savings, a UE may include or be associated with a second, low-power wakeup radio (LP-WUR). Relative to a non-LP-WUR (e.g., a main radio (MR) of the UE), the LP-WUR may have reduced power consumption. For example, the LP-WUR may be configured with a reduced bandwidth, reduced processing capabilities, or other reduced capabilities, relative to a main radio, which facilitate operation with reduced power consumption. In one particular example, the LP-WUR may be configured to use an envelope detector type of receiver architecture, with on-off keying (OOK) modulation, to enable a UE to perform signaling monitoring with low power consumption.

The LP-WUR may facilitate indication, from the network, for the UE to exit a low power state, such as by waking up the main radio. For example, while the main radio is in a low power state, the LP-WUR may receive a signal referred to as a low-power wakeup signal (LP-WUS), and may trigger the main radio to exit the low power state and may trigger a UE to transfer from an idle mode to an active mode to receive PDCCH paging. In another example, when a UE is operating in a connected mode, the LP-WUS may trigger UE PDCCH monitoring. In some configurations, the LP-WUS/LP-WUR can be implemented in conjunction with a C-DRX cycle, such that the main radio may skip an on duration if the LP-WUR has not received an LP-WUS in association with (e.g., before) the on duration, thereby further reducing power consumption relative to waking up in an on duration in which the UE will not receive a PDCCH communication.

An always-on broadcast signal, such as an LP-WUS or a low-power synchronization signal (LP-SS) may consume additional power at a network node relative to periodic broadcast signals. For example, when performing a cell-specific type of transmission of an LP-WUS, each cell is assigned orthogonal resources for OOK modulated signals and each cell transmits a corresponding LP-WUS at a configured full power level to enable detection of a cell-specific signal by UEs in the cell (including UEs in areas proximate to a cell boundary).

Various aspects relate generally to single frequency network (SFN)-type LP-WUS transmission for waking up idle UEs for paging PDCCH monitoring. Some aspects more specifically relate to performing an SFN-type of transmission of an LP-WUS, in which each cell, of a set of cells, transmits a coordinated LP-WUS. Accordingly, transmissions from different cells of the same signal in the same resources results in power boosting (e.g., inter-cell interference causes signal gain). In other words, for SFN-types of transmissions, each individual cell may transmit at less than the configured full power level, while still enabling detection by UEs in each cell (including UEs in areas proximate to a cell boundary). Accordingly, SFN-type LP-WUS transmission may be introduced for power savings by network nodes (and to enable power savings by UEs that use LP-WURs). In some aspects, a set of cells in which an SFN LP-WUS communication is transmitted (e.g., via a set of transmissions by a set of transmitters) may be based on a tracking area (TA) with a tracking area code (TAC), a registration area (RA) of a UE to which the SFN LP-WUS communication is directed, or a configured set of cells across TAs. In some aspects, a core node may set a configuration, for a network node and/or a UE, for the SFN LP-WUS communication. For example, the core node may indicate one or more parameters of the SFN LP-WUS, such as a monitoring period, a periodicity, or a set of cells on which the SFN LP-WUS is to be transmitted, among other examples.

Particular aspects of the subject matter described in this disclosure can be implemented to realize one or more of the following potential advantages. In some examples, the described techniques can be used to coordinate SFN-type LP-WUS transmission in a selected set of cells. By coordinating SFN-type LP-WUS transmission, the SFN-type LP-WUS transmission can be used to convey LP-WUS messages to UEs in a cell (including UEs in areas proximate to a cell boundary) with reduced power consumption at transmitting network nodes. Additionally, or alternatively, by enabling SFN-type LP-WUS transmission, the described techniques reduce power consumption of UEs that use an LP-WUR for wake-up signal monitoring and an MR for other communication relative to UEs that use only a single, main radio for monitoring and communication.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

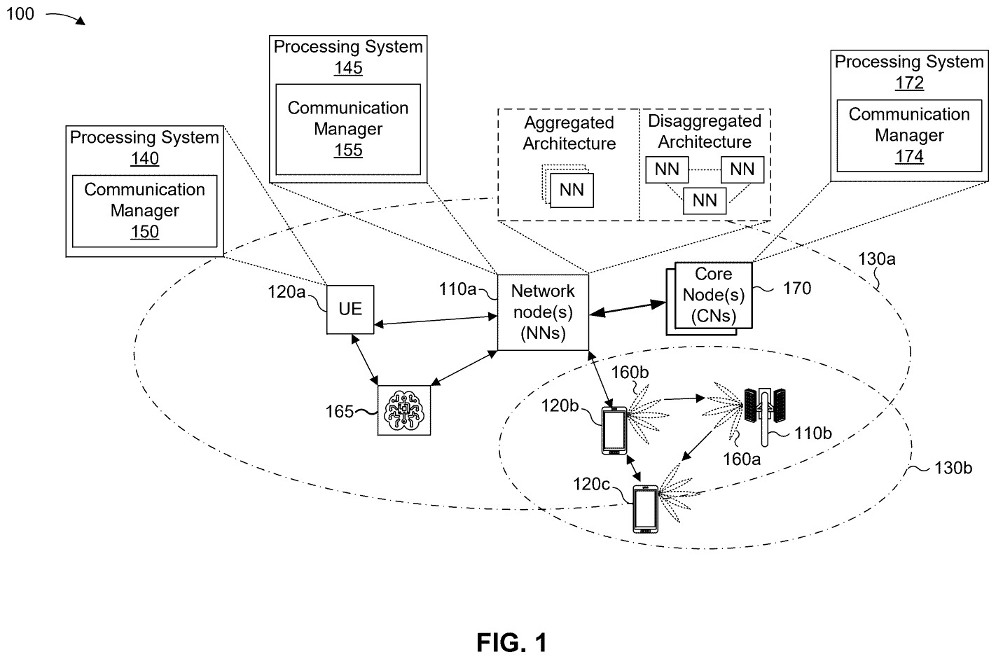

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110. For example, the network nodes 110 may communicate with core nodes 170 of a core network. A core node 170 may include a scheduling node, an operations and management (OAM) node, or another type of node.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A processing system (e.g., the processing system 140 and/or the processing system 145) may generally be a system or a series of machines or components that receives inputs and processes the inputs to produce a set of outputs (which may be passed to other systems or components of, for example, the UE 120). For example, the processing system 140 of the UE 120 may be a system that includes the various other components or subcomponents of the UE 120. The processing system 140 of the network node 110 may be a system that includes the various other components or subcomponents of the network node 110.

The processing system 145 of the network node 110 may interface with one or more other components of the network node 110, may process information received from one or more other components (such as inputs or signals), or may output information to one or more other components. For example, a chip or modem of the network node 110 may include the processing system 145, a first interface to receive or obtain information, and a second interface to output, transmit, or provide information. In some examples, the first interface may be an interface between the processing system 145 of the chip or modem and a receiver, such that the network node 110 may receive information or signal inputs, and the information may be passed to the processing system 145. In some examples, the second interface may be an interface between the processing system 145 of the chip or modem and a transmitter, such that the network node 110 may transmit information output from the chip or modem. Similarly, the processing system 140 of the UE 120 may interface with one or more other components of the UE 120, may process information received from one or more other components (such as inputs or signals), or may output information to one or more other components. For example, a chip or modem of the UE 120 may include the processing system 140, a first interface to receive or obtain information, and a second interface to output, transmit, or provide information. In some examples, the first interface may be an interface between the processing system 140 of the chip or modem and a receiver, such that the UE 120 may receive information or signal inputs, and the information may be passed to the processing system 140. In some examples, the second interface may be an interface between the processing system 140 of the chip or modem and a transmitter, such that the UE 120 may transmit information output from the chip or modem. A person having ordinary skill in the art will readily recognize that the second interface described above also may obtain or receive information or signal inputs, and the first interface described above may also output, transmit, or provide information.

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

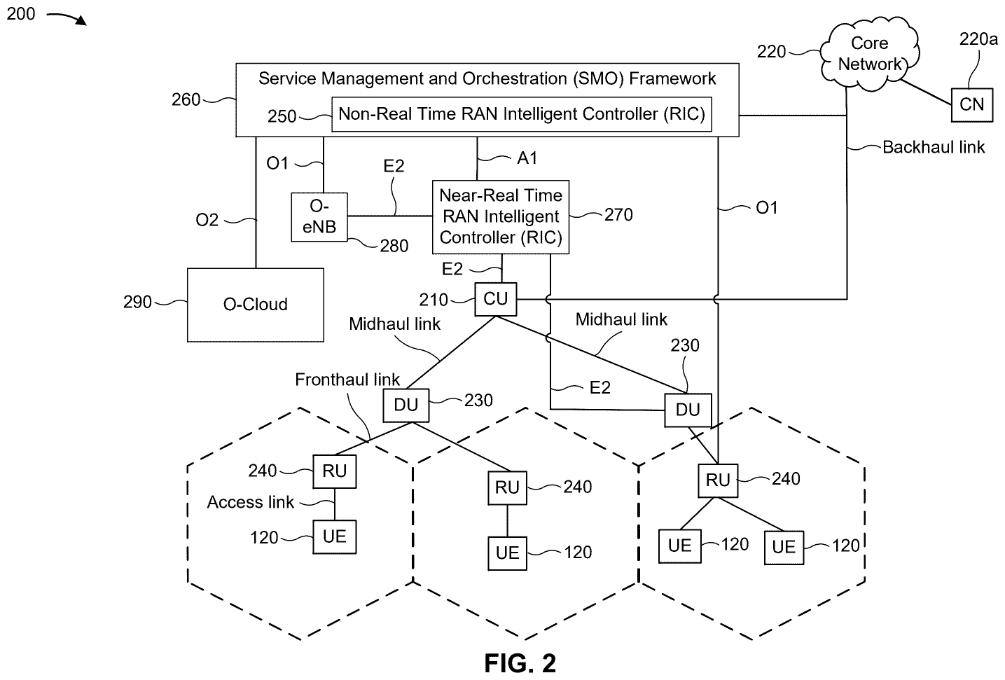

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Network energy saving (NES) and/or network energy efficiency measures are expected to have increased importance in wireless network operations for various reasons, such as climate change mitigation, environmental sustainability, and/or network cost reduction, among other examples. For example, although NR generally offers a significant energy efficiency improvement per gigabyte over previous generations (for example, LTE), new NR use cases and/or the adoption of millimeter wave frequencies may require more network sites, more network antennas, larger bandwidths, and/or more frequency bands, among other examples which may lead to more efficient wireless networks that nonetheless have higher energy requirements and/or cause more emissions than previous wireless network generations. Furthermore, energy accounts for a significant proportion of the cost to operate a wireless network. For example, according to some estimates, energy costs are about one-fourth the total cost to operate a wireless network, and over 90% of network operating costs are spent on energy (for example, fuel and electricity). The largest proportion of energy consumption and/or energy costs are associated with a radio access network (RAN), which accounts for about half of the energy consumption in a wireless network, with data centers and fiber transport accounting for smaller shares. Accordingly, measures to increase network energy savings and/or improve network energy efficiency are factors that may drive adoption and/or expansion of wireless networks.

In some examples, a UE 120 or network node 110 may implement power saving features (also referred to as energy saving features). Power saving features may include, for example, relaxed radio resource monitoring (such as relaxed reference signal monitoring for devices operating in low mobility or in good radio conditions), discontinuous reception (DRX) operation, reduced PDCCH monitoring during DRX active times, on-demand system information transmission, on-demand synchronization signal block (SSB) transmission, antenna port adaptation, advanced channel state information (CSI) reporting, and/or power-efficient paging transmission and reception.

In some examples, a UE 120 may operate in association with a DRX configuration (for example, indicated to the UE 120 by a network node 110). DRX operation may enable the UE 120 to enter a sleep mode or state at various times while in the coverage area of a network node 110 to reduce power consumption for conserving battery resources, among other examples. The DRX configuration generally configures the UE 120 to operate in association with a DRX cycle. The UE 120 may repeat DRX cycles with a configured periodicity according to the DRX configuration. A DRX cycle may include a DRX on duration during which the UE 120 is in an awake mode or in an active state. A DRX cycle may also include one or more durations during which the UE 120 may operate in an inactive state. The one or more durations in which the UE 120 may operate in an inactive state may be opportunities for the UE 120 to enter a DRX sleep mode in which the UE 120 may refrain from monitoring for communications from a network node 110. Additionally or alternatively, the UE 120 may deactivate one or more antennas, RF chains, and/or other hardware components or devices while operating in the DRX sleep mode.

The time during which the UE 120 is configured to be in an active state during a DRX on duration may be referred to as an active time, and the time during which the UE 120 is configured to be in an inactive state, such as during a DRX sleep duration, may be referred to as an inactive time. During a DRX on duration, the UE 120 may monitor for downlink communications from one or more network nodes 110. If the UE 120 does not detect and/or does not successfully decode any downlink communications during the DRX on duration, the UE 120 may enter a DRX sleep mode for the inactive time duration at the end of the DRX on duration. If the UE 120 detects and/or successfully decodes a downlink communication during the DRX on duration, the UE 120 may remain in the active state for the duration of a DRX inactivity timer (which may extend the active time). The UE 120 may start the DRX inactivity timer at a time at which the downlink communication is received. The UE 120 may remain in the active state until the DRX inactivity timer expires, at which time the UE 120 may transition to the sleep mode for an inactive time duration. Additionally or alternatively, the UE 120 may use a DRX cycle referred to as an extended DRX (eDRX) cycle, such as for use cases that are tolerant to latency. An eDRX cycle may include a relatively longer inactive time relative to a baseline DRX cycle (for example, an eDRX cycle may have a lower ratio of active time to inactive time).

As described above, a UE 120 may achieve additional power savings in connection with a DRX mode by using an LP-WUR to monitor for an LP-WUS. For example, the LP-WUR may use reduced power resources relative to a main radio, so a UE 120 may achieve power savings by using the LP-WUR to monitor for a wake-up signal that triggers a transition to an active mode (and use of the main radio) relative to using the main radio to monitor for a signal that triggers a transition to an active mode. An LP-WUR may be used, by a UE 120, in connection with a DRX mode or separate from a DRX mode (e.g., to reduce power consumption associated with other monitoring procedures).

As described above, a substantial proportion of power utilization, in a wireless communication network such as the wireless communication network 100, may occur in connection with operations of the network nodes 110. For example, a network node 110 may transmit an LP-WUS at a maximum power in a cell to ensure that a UE 120 in the cell (e.g., at a cell edge) can successfully receive the LP-WUS using an LP-WUR. As described in more detail herein, some wireless communications networks 100 may introduce SFN-type LP-WUS signaling to reduce power consumption from operations of the network nodes 110. For example, by transmitting an LP-WUS communication, via a set of transmitters for a set of cells (e.g., transmitters of one or more network nodes 110), each transmitter may transmit at less than the maximum power in the cell. Based on each transmitter transmitting a coordinated signal in the same resources, inter-cell interference may cause a gain to the coordinated signal at cell edges (e.g., rather than causing noise), which enables a threshold level of signal strength (and detection of the LP-WUS communication by an LP-WUR of a UE 120) with the reduced transmit power and the reduced power consumption.

In some aspects, the UE 120 may include a communication manager 150. As described in more detail elsewhere herein, the communication manager 150 may receive, using a first transmit/receive (Tx/Rx) chain, a low-power wake-up signal (LP-WUS) communication, wherein the LP-WUS communication is conveyed via a set of single frequency network (SFN)-type transmissions from a set of transmitters associated with a set of cells; and communicate, using a second Tx/Rx chain, in one or more resources in connection with the LP-WUS. Additionally, or alternatively, the communication manager 150 may perform one or more other operations described herein.

In some aspects, the network node 110 may include a communication manager 155. As described in more detail elsewhere herein, the communication manager 155 may transmit a transmission of an LP-WUS communication, wherein the transmission of the LP-WUS communication is conveyed via a SFN-type transmission, of a set of SFN-type transmissions, and wherein the transmission of the LP-WUS is coordinated with a set of transmitters associated with a set of cells; and communicate in one or more resources in connection with the LP-WUS. Additionally, or alternatively, the communication manager 155 may perform one or more other operations described herein.

In some aspects, the core node 170 may include a communication manager 174. As described in more detail elsewhere herein, the communication manager 174 may identify a configuration for a set of cells for transmission of an LP-WUS communication, wherein transmission of the LP-WUS communication is conveyed via a set of SFN-type transmissions from a set of transmitters and in a set of cells; and send, to a set of network nodes associated with the set of transmitters, information identifying the configuration to cause the transmission of the LP-WUS communication via the set of SFN-type transmissions in the set of cells. Additionally, or alternatively, the communication manager 174 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core node (CN) 220a of a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

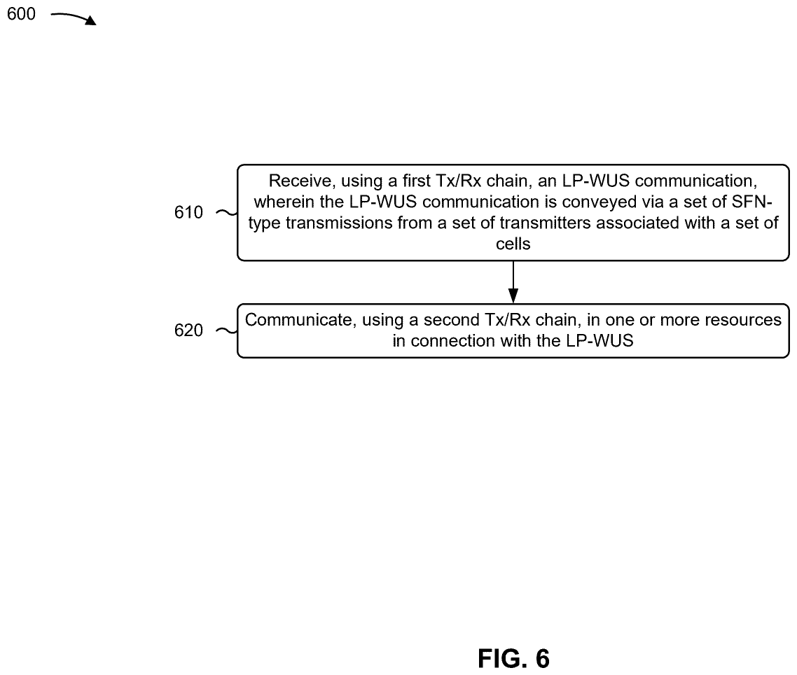

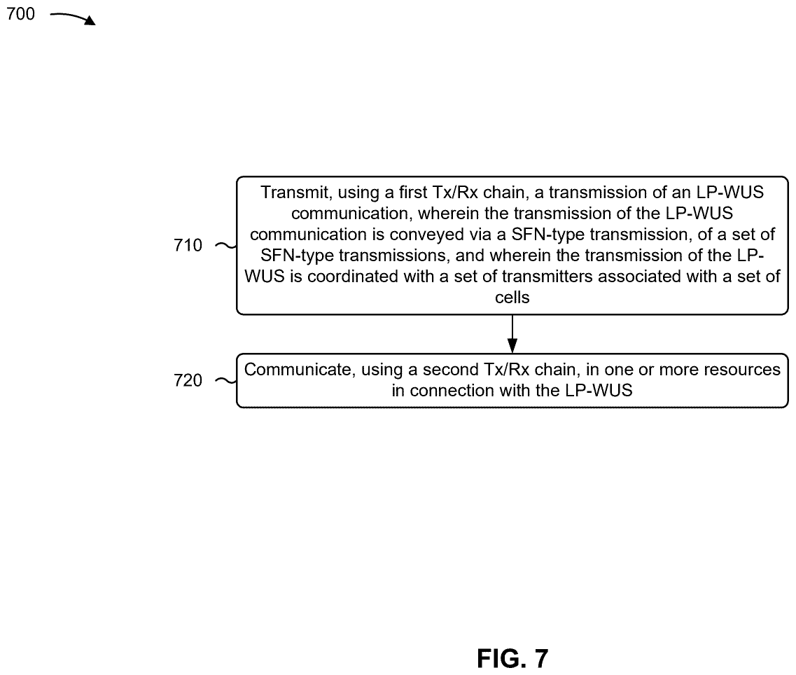

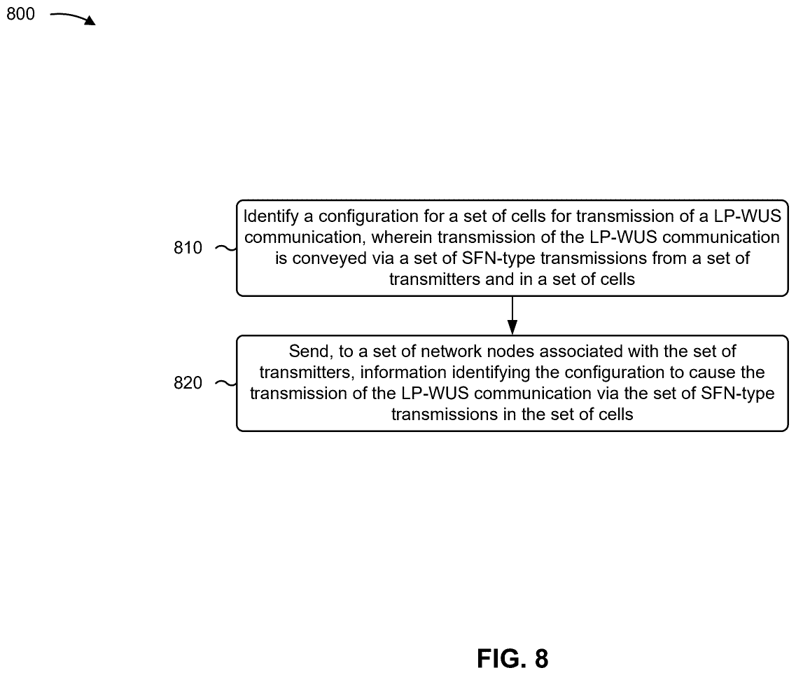

The network node 110, the processing system 145 of the network node 110, the UE 120, the processing system 140 of the UE 120, the core node 170, the processing system 172 of the core node 170, the CU 210, the DU 230, the RU 240, or any other component(s) of FIG. 1 and/or FIG. 2 may implement one or more techniques or perform one or more operations associated with SFN transmission, as described in more detail elsewhere herein. For example, the processing system 145 of the network node 110, the processing system 140 of the UE 120, the processing system 172 of the core node 170, the CU 210, the DU 230, or the RU 240 may perform or direct operations of, for example, process 600 of FIG. 6, process 700 of FIG. 7, process 800 of FIG. 8, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. Memory of a core node 170 may store data and program code (or instructions) for the core node 170. In some examples, the memory of the core node 170 may store data relating to a network node 110 or a UE 120, such as configuration information, state information, or device context information In some examples, the memory of the UE 120, the memory of the network node 110, or the memory of the core node 170, may include a non-transitory computer-readable medium storing a set of instructions for wireless communication. For example, the set of instructions, when executed by one or more processors (for example, of the processing system 145, the processing system 140, or the processing system 172) of the network node 110, the UE 120, the CU 210, the DU 230, or the RU 240, may cause the one or more processors to perform process 600 of FIG. 6, process 700 of FIG. 7, process 800 of FIG. 8, or other processes as described herein. In some examples, executing instructions may include running the instructions, converting the instructions, compiling the instructions, and/or interpreting the instructions, among other examples.

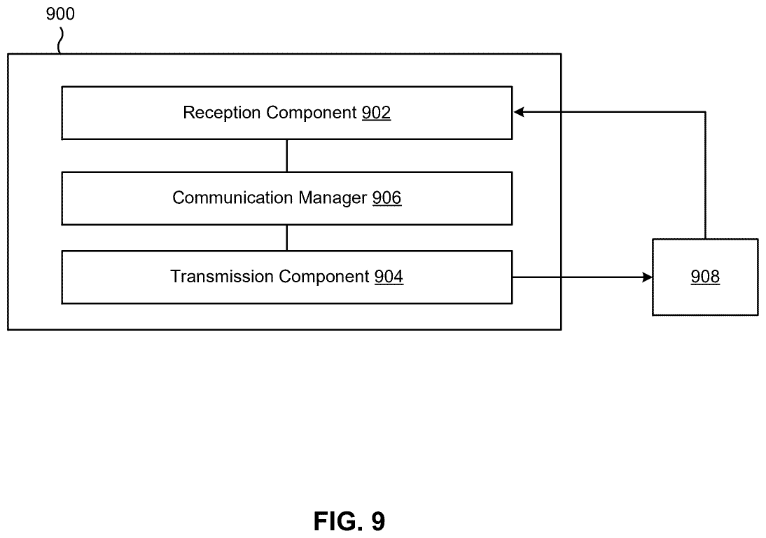

In some aspects, the UE 120 includes means for receiving, using a first Tx/Rx chain, an LP-WUS communication, wherein the LP-WUS communication is conveyed via a set of SFN-type transmissions from a set of transmitters associated with a set of cells; and/or means for communicating, using a second Tx/Rx chain, in one or more resources in connection with the LP-WUS. The means for the UE 120 to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9) and/or a transmission component (for example, transmission component 904 depicted and described in connection with FIG. 9), among other examples.

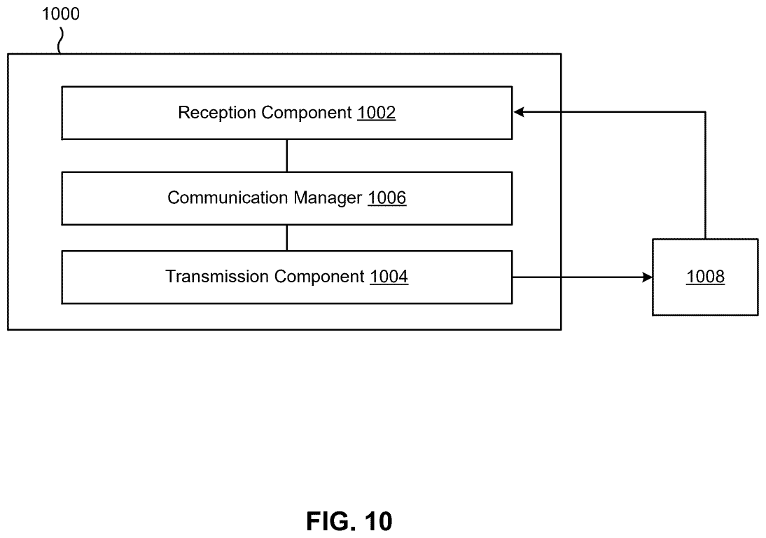

In some aspects, the network node 110 includes means for transmitting a transmission of an LP-WUS communication, wherein the transmission of the LP-WUS communication is conveyed via a SFN-type transmission, of a set of SFN-type transmissions, and wherein the transmission of the LP-WUS is coordinated with a set of transmitters associated with a set of cells; and/or means for communicating in one or more resources in connection with the LP-WUS. The means for the network node 110 to perform operations described herein may include, for example, one or more of communication manager 155, processing system 145, a radio, one or more RF chains, one or more transceivers, one or more antennas, one or more modems, a reception component (for example, reception component 1002 depicted and described in connection with FIG. 10) and/or a transmission component (for example, transmission component 1004 depicted and described in connection with FIG. 10), among other examples.

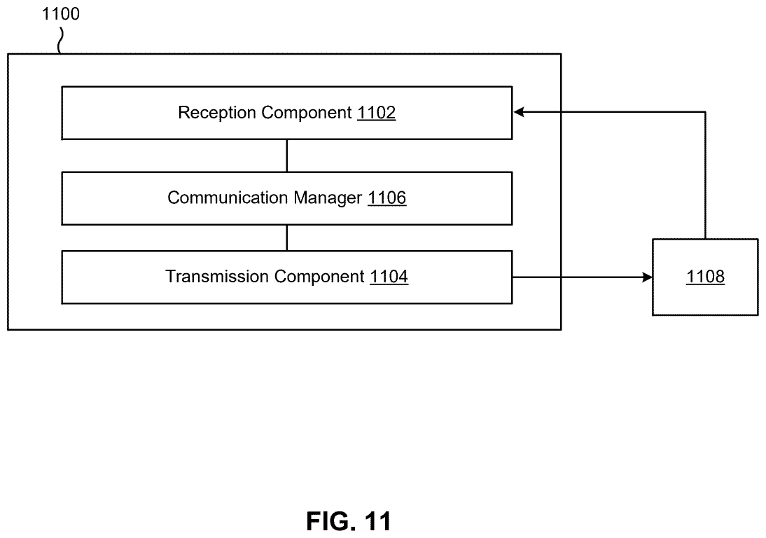

In some aspects, the core node 170 includes means for identifying a configuration for a set of cells for transmission of an LP-WUS communication, wherein transmission of the LP-WUS communication is conveyed via a set of SFN-type transmissions from a set of transmitters and in a set of cells; and/or means for sending, to a set of network nodes associated with the set of transmitters, information identifying the configuration to cause the transmission of the LP-WUS communication via the set of SFN-type transmissions in the set of cells. In some aspects, the means for the core node 170 to perform operations described herein may include, for example, one or more of communication manager 174, processing system 172, a radio, one or more RF chains, one or more transceivers, one or more antennas, one or more modems, a reception component (for example, reception component 1102 depicted and described in connection with FIG. 11), and/or a transmission component (for example, transmission component 1104 depicted and described in connection with FIG. 11), among other examples.

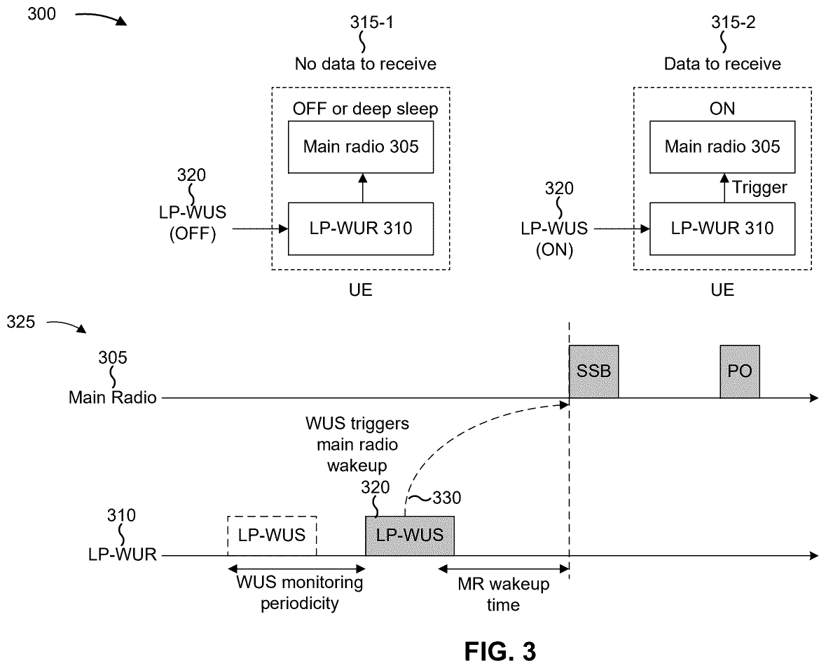

FIG. 3 is a diagram illustrating an example 300 of an LP-WUR and an LP-WUS, in accordance with the present disclosure. As shown in FIG. 3, a UE (e.g., UE 120) may be equipped with a communication system that includes a main radio 305 and an LP-WUR 310 to reduce power consumption and enable low latency. For example, power saving and low latency are often conflicting goals because placing one or more components into a sleep state more often to reduce power consumption also increases latency (e.g., because data cannot be transmitted and/or received while the one or more components are in the sleep state), and because reducing the time that one or more components spend in a sleep state to reduce latency can lead to increased power consumption. Accordingly, as shown in FIG. 3, the UE may be equipped with the LP-WUR 310, which may be considered a companion receiver that can be used with a main radio 305 to reduce power consumption and latency.

For example, in some aspects, the UE may generally use the main radio 305 to transmit and/or receive user data, and the main radio 305 may be turned off or operated in a deep sleep state unless there is user data to transmit and/or receive. In some examples, the main radio 305 may be associated with a first Tx/Rx chain, which include a first set of components, such as a first serial-to-parallel (S/P) converter, a first mapper, a first inverse fast Fourier transformer (IFFT) component, a first parallel-to-serial (P/S) converter, a first radio frequency (RF) component, or a first antenna, among other examples. Furthermore, the LP-WUR 310 may serve as a simple wakeup receiver for the main radio 305, and the LP-WUR 310 may be active and monitoring for an LP-WUS while the main radio 305 is off or in the deep sleep state. In some examples, the LP-WUR 310 may be associated with a second Tx/Rx chain, which may include a second set of components, such as a second S/P converter, a second mapper, a second IFFT component, a second P/S converter, a second RF component, or a second antenna, among other examples. In some examples, the main radio 305 and the LP-WUR 310 may share one or more first components and have a separate one or more second components. In some examples, the LP-WUR 310 may have a simplified architecture or set of components relative to the main radio 305. For example, the LP-WUR 310 may include an envelope detector, as described in more detail herein, which may detect a channel with reduced power consumption relative to the main radio 305, but which may have reduced capabilities relative to the main radio 305. Additional details regarding LP-WURs are described with regard to 3GPP Technical Report (TR) 38.869, Version 18.0.0.

Reference number 315-1 depicts a first state associated with the main radio 305 and the LP-WUR 310 where there is no user data to be provided to the main radio 305. In such cases, the main radio 305 may be off or operated in the deep sleep state unless there is user data to transmit, and the LP-WUR 310 may monitor for an LP-WUS (for example, continuously, or periodically in monitoring occasions that are separated in time). Furthermore, reference number 315-2 depicts a second state associated with the main radio 305 and the LP-WUR 310 where there is user data for the main radio 305. In such cases, the LP-WUR 310 may receive an LP-WUS 320 (such as from a network node 110) and may provide a trigger to wake or otherwise activate the main radio 305 based on detecting the LP-WUS 320. Accordingly, the main radio 305 may then transmit and/or receive user data.

In general, the LP-WUR 310 may consume very little power (for example a target power consumption less than 100 microwatts (μW) in the active state), which may be achieved using simple modulation schemes (e.g., OOK modulation), a narrow bandwidth (for example, less than 5 MHz), and/or other suitable techniques. In this way, the LP-WUR 310 can be used to reduce the time that the main radio 305 spends in an on state and/or may avoid unnecessarily waking the main radio 305 from the off or deep sleep state when there is no user data to transmit or receive, which tends to be costly from a power consumption perspective. Furthermore, because the LP-WUR 310 has a very low power consumption, the LP-WUR 310 can be used to frequently or continuously perform LP-WUS monitoring, which may improve latency because the main radio 305 can be woken up when there is user data that the main radio 305 needs to receive. For example, the LP-WUR 310 may not suffer from the latency versus power efficiency tradeoff associated with duty cycling schemes, such as DRX. Furthermore, in addition to performing LP-WUS monitoring, which may be used for paging reception, the LP-WUR 310 may monitor an LP-SS for time and frequency tracking and radio resource management (RRM) measurement. In this way, by monitoring the LP-SS, serving cell and/or neighbor cell monitoring can be offloaded from the main radio 305 to the LP-WUR 310 to reduce how often the main radio 305 is woken up, which can further reduce power consumption.

In some aspects, the LP-WUR 310 may include an OOK WUR (also referred to as an envelope detector (ED) WUR). An OOK WUR may only detect the amplitude (such as the magnitude) of a received signal. A UE that uses an OOK WUR may detect the phase of a received signal by activating the main radio 305.

In some aspects, the LP-WUR 310 may include an OFDM WUR (which may be referred to as an in-phase and quadrature (IQ) WUR). An OFDM WUR can detect both the amplitude and phase of a received signal. For example, an OFDM WUR can obtain first information that is modulated onto a signal using OOK modulation, and second information that is modulated onto the signal using phase modulation.

In some aspects, as shown by reference number 325, one application of the LP-WUR 310 is to monitor the LP-WUS 320 for paging monitoring, which can be used to reduce unnecessary paging reception performed by the main radio 305. For example, as shown in FIG. 3, the LP-WUR 310 may be configured to monitor for an LP-WUS 320 (while the main radio 305 is off or in a deep sleep state) according to a WUS monitoring periodicity. For example, the LP-WUR 310 may monitor for the LP-WUS 320 in periodic LP-WUS monitoring occasions that are spaced in time according to the WUS monitoring periodicity. Alternatively, although not explicitly shown in FIG. 3, the LP-WUR 310 may be configured to continuously monitor for the LP-WUS 320. In general, a network node may transmit an LP-WUS 320 to a UE only in cases where there is a paging message that needs to be sent to the UE while the UE is in an idle or inactive state (such as an RRC idle or RRC inactive state). In such cases, as shown by reference number 330, the LP-WUR 310 may receive and detect the LP-WUS 320, which may trigger the LP-WUR 310 to wake up the main radio 305. In some aspects, the LP-WUS 320 may be a sequence-based WUS, which may include a predefined set of sequences (implemented, for example, using OOK modulation and/or phase modulation). As shown, the main radio 305 may wake up after a main radio wakeup time, and may then start to monitor one or more synchronization signal block (SSB) transmissions to obtain synchronization with the network node before monitoring and receiving the paging message in a subsequent PO.

Otherwise, in cases where the LP-WUR 310 does not detect the LP-WUS 320, the main radio 305 may remain in the deep sleep state to save power.

As indicated above, FIG. 3 is provided as an example. Other examples may differ from what is described with respect to FIG. 3.

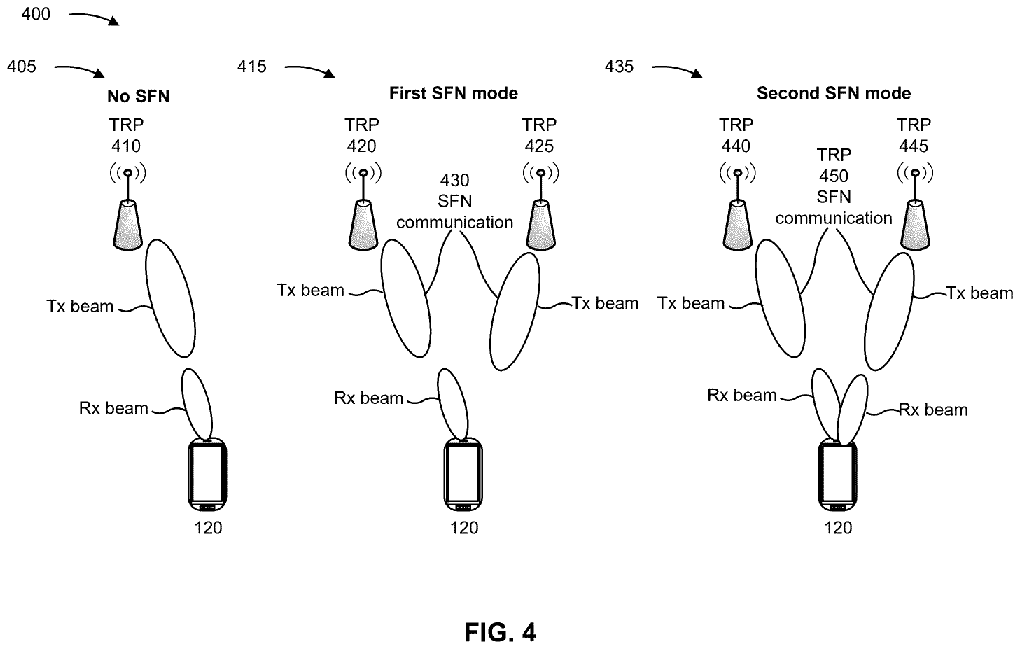

FIG. 4 is a diagram illustrating an example 400 associated with SFN communication, in accordance with the present disclosure.

In some cases, a UE may operate in an SFN. An SFN may be a network configuration in which a set of cells (e.g., a plurality of cells associated with a plurality of network nodes or a plurality of cells associated with a single network node) simultaneously transmit the same signal over the same frequency channel. Unless described otherwise, as used herein, “SFN transmissions” may refer to two or more transmissions that are transmitted using the same (or substantially the same) time domain resources and frequency domain resources. For example, an SFN may be a broadcast network. Nevertheless, in some cases, as a result of certain configurations, only a single transmission may be transmitted in an SFN network. In such cases, the single transmission may still be considered an SFN-type transmission (if transmitted in accordance with a configuration for SFN transmission). In other words, it is understood that if a tracking area is selected for SFN transmission, as described in more detail herein, and the tracking area includes only a single cell, transmission in the tracking area can still be considered SFN-type transmission.

An SFN may enable an extended coverage area without the use of additional frequencies. For example, an SFN configuration may include multiple network nodes in an SFN area that transmit one or more identical signals using the same frequency at the same, or substantially the same, time. In some aspects, an SFN configuration may include other network devices, such as multiple TRPs corresponding to the same network node. A TRP may include a network node 110, a DU, and/or an RU, among other examples. The multiple TRPs may provide coverage for an SFN area. The multiple TRPs may transmit one or more identical signals using the same frequency at the same, or substantially the same, time. In some examples, the identical signal(s) simultaneously transmitted by the multiple network nodes (and/or multiple TRPs) may include a PDSCH signal, a CORESET scheduling the PDSCH, and/or a reference signal (e.g., an SSB, a CSI-RS, a tracking reference signal (TRS), or other reference signals), among other examples.

As shown by reference number 405, an example of communications that do not use an SFN configuration is depicted. A TRP 410 may transmit communications using a transmit (Tx) beam to the UE 120. The transmit beam may be associated with a TCI state. The UE 120 may receive communications (e.g., transmitted by the TRP 410) using a receive (Rx) beam. For example, the UE 120 may identify the TCI state associated with the transmit beam and may use information provided by the TCI state to receive the communications.

As shown by reference number 415, an example of a first SFN mode is depicted. As shown in FIG. 4, a first TRP 420 (or a first network node 110) and a second TRP 425 (or a second network node 110) may transmit an SFN communication 430 to the UE 120. For example, the first TRP 420 and the second TRP 425 may transmit substantially the same information (e.g., the SFN communication 430) to the UE 120 using the same frequency domain resources and the same time domain resources. The first TRP 420 may transmit the SFN communication 430 using a first transmit beam. The second TRP 425 may transmit the SFN communication 430 using a second transmit beam. In the first SFN mode, the UE 120 may be unaware that the SFN communication 430 is transmitted on separate transmit beams (e.g., from different TRPs and/or different network nodes 110). Accordingly, when the multiple network nodes (and/or multiple TRPs) simultaneously transmit the same signal to a UE 120, the SFN configuration may be transparent to the UE 120, and the UE 120 may aggregate, or accumulate, the simultaneous signal transmissions from the multiple TRPs (and/or multiple network nodes 110), which may provide higher signal quality or higher tolerance for multipath attenuation, among other benefits. For example, the UE 120 may receive the SFN communication 430 using a single receive beam (e.g., may use a single spatial receive direction, among other examples, to receive the SFN communication 430). In other words, TCI states of the different transmit beams used to transmit the SFN communication 430 may not be signaled to the UE 120.

As shown by reference number 435, an example of a second SFN mode is depicted. As shown in FIG. 4, a first TRP 440 (or a first network node 110) and a second TRP 445 (or a second network node 110) may transmit an SFN communication 450 to the UE 120. For example, the first TRP 440 and the second TRP 445 may transmit substantially the same information (e.g., the SFN communication 450) to the UE 120 using the same frequency domain resources and the same time domain resources. The first TRP 440 may transmit the SFN communication 450 using a first transmit beam. The second TRP 445 may transmit the SFN communication 450 using a second transmit beam. In the second SFN mode, the UE 120 may be aware that the SFN communication 450 is transmitted on separate transmit beams (e.g., from different TRPs and/or different network nodes 110). For example, a first TCI state of the first transmit beam (e.g., associated with the first TRP 440) and a second TCI state of the second transmit beam (e.g., associated with the second TRP 445) may be signaled to the UE 120. For example, a network node 110 may transmit configuration information (e.g., directly to the UE 120 or to the UE 120 via one or more network nodes) that indicates that the SFN communication 450 may be a combination of transmissions from different TRPs and/or different transmit beams. The UE 120 may use the information associated with the different TRPs and/or different transmit beams (e.g., the first TCI state and the second TCI state) to improve a reception performance of the SFN communication 450. For example, as shown in FIG. 4, the UE 120 may use different spatial directions (e.g., different receive beams) to receive the SFN communication 450 based at least in part on the TCI states of the transmit beam(s) associated with the SFN communication 450. This may improve a performance of the UE 120 because the UE 120 may receive the SFN communication 450 from different transmit beams and/or different TRPs with improved signal strength and/or signal quality, among other examples.

As indicated above, FIG. 4 is provided as an example. Other examples may differ from what is described with respect to FIG. 4.

An always-on broadcast signal, such as an LP-WUS or a low-power synchronization signal (LP-SS) may consume additional power at a network node relative to periodic broadcast signals. For example, when performing a cell-specific type of transmission of an LP-WUS, each cell is assigned orthogonal resources for OOK modulated signals and each cell transmits a corresponding LP-WUS at a configured full power level to enable detection of a cell-specific signal by UEs in the cell (including UEs in areas proximate to a cell boundary).

Various aspects relate generally to SFN-type LP-WUS transmission for waking up idle UEs for paging PDCCH monitoring. Some aspects more specifically relate to performing an SFN-type of transmission of an LP-WUS, in which each cell, of a set of cells, transmits a coordinated LP-WUS. Accordingly, transmissions from different cells of the same signal in the same resources results in power boosting (e.g., inter-cell interference causes signal gain). In other words, for SFN-types of transmissions, each individual cell may transmit at less than the configured full power level, while still enabling detection by UEs in each cell (including UEs in areas proximate to a cell boundary). Accordingly, SFN-type LP-WUS transmission may be introduced for power savings by network nodes (and to enable power savings by UEs that use LP-WURs). In some aspects, a set of cells in which an SFN LP-WUS communication is transmitted (e.g., via a set of transmissions by a set of transmitters) may be based on a tracking area (TA) with a tracking area code (TAC), a registration area (RA) of a UE to which the SFN LP-WUS communication is directed, or a configured set of cells across TAs. In some aspects, a core node may set a configuration, for a network node and/or a UE, for the SFN LP-WUS communication. For example, the core node may indicate one or more parameters of the SFN LP-WUS, such as a monitoring period, a periodicity, or a set of cells on which the SFN LP-WUS is to be transmitted, among other examples.

Particular aspects of the subject matter described in this disclosure can be implemented to realize one or more of the following potential advantages. In some examples, the described techniques can be used to coordinate SFN-type LP-WUS transmission in a selected set of cells. By coordinating SFN-type LP-WUS transmission, the SFN-type LP-WUS transmission can be used to convey LP-WUS messages to UEs in a cell (including UEs in areas proximate to a cell boundary) with reduced power consumption at transmitting network nodes. Additionally, or alternatively, by enabling SFN-type LP-WUS transmission, the described techniques reduce power consumption of UEs that use an LP-WUR for wake-up signaling monitoring and an MR for other communication relative to UEs that use only a single, main radio for monitoring and communication.

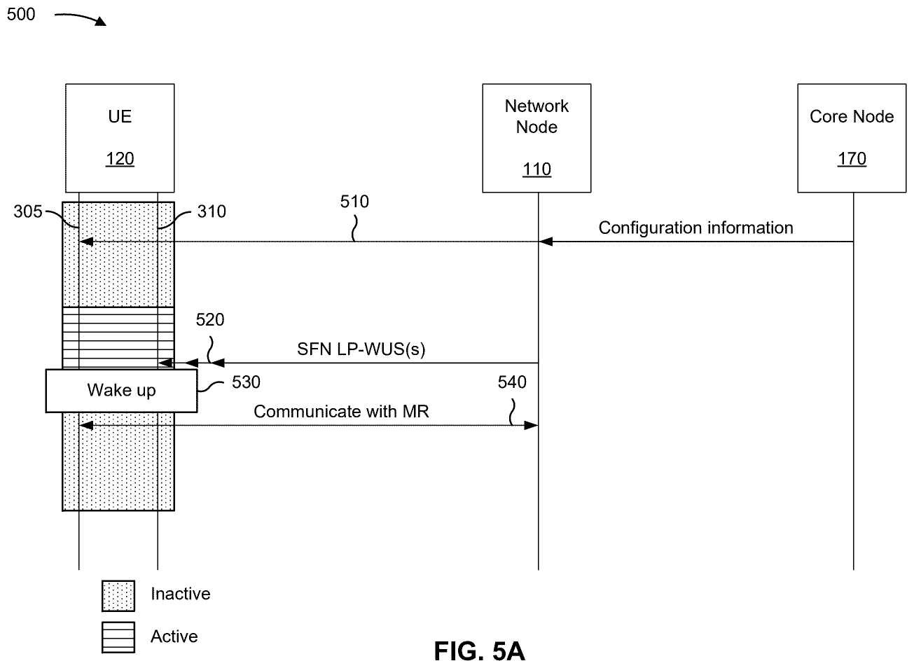

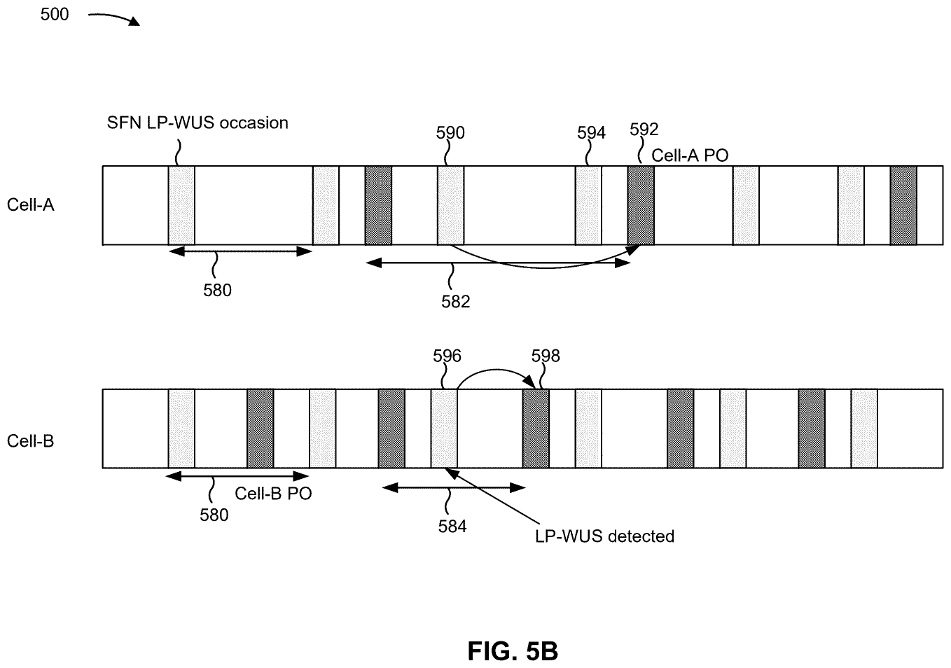

FIGS. 5A-5B are diagrams illustrating an example 500 associated with SFN transmission, in accordance with the present disclosure. As shown in FIG. 5A, example 500 includes communication between a network node 110, a core node 170, and a UE 120. In some aspects, the UE 120 includes an LP-WUR 310 associated with a first Tx/Rx chain and a main radio 305 associated with a second Tx/Rx chain.

As further shown in FIG. 5A, and by reference number 510, the network node 110 and/or the UE 120 may receive configuration information. For example, the network node 110 may receive configuration information for SFN-type LP-WUS transmission from the core node 170 and may provide configuration information (e.g., the same or other configuration information) to the UE 120. Although some aspects are described herein in terms of an SFN-type LP-WUS, it is contemplated that aspects described herein may be used for other SFN-type transmissions, such as low power synchronization signal (LP-SS) transmission. In some aspects, a configuration of the UE 120 or the network node 110 may include static configuration information. For example, the UE 120 may receive first configuration information from the network node 110 (e.g., identifying a first set of parameters of a configuration) and may have stored (e.g., in accordance with a standard or specification) second configuration information (e.g., identifying a second set of parameters of the configuration).

In some aspects, a configuration (e.g., of the network node 110 or the UE 120 for LP-WUS signaling) may include information identifying a set of cells in which an LP-WUS is to be transmitted. For example, an SFN-type LP-WUS may be configured (e.g., by the core node 170 or as a statically specified configuration) for all cells of a tracking area (TA). The TA, which may be identified by a tracking area code (TAC), may include a set of cells associated with an area (e.g., a geographical area). When a UE 120 is to receive paging (e.g., monitoring for which is triggered by the LP-WUS), the network node 110 may be configured to transmit the LP-WUS message and/or the subsequent paging to a registration area (RA) of the UE 120. In this case, the RA of the UE 120 may include one or more TAs to which the LP-WUS message is transmitted to trigger monitoring by the UE 120. Within a public land mobile network (PLMN) each TA is associated with a unique identifier and may be associated with a set of resources (e.g., time resources or frequency resources) for SFN-type LP-WUS transmission. In some aspects, when the UE 120 changes TAs, the UE 120 may determine a new resource configuration. For example, when SFN-type LP-WUS transmission resources are allocated on a TA-specific basis, the UE 120 may determine a new resource configuration for receiving an SFN-type LP-WUS communication when the UE 120 changes TAs.

In some aspects, a set of cells in which the LP-WUS is to be transmitted is configured across TAs. In other words, rather than a network node 110 being configured to transmit an LP-WUS in cells of a particular TA, the network node 110 may be configured with a set of cells for LP-WUS transmission, which may differ from the particular TA. In other words, the network node 110 may be configured with a set of cells that includes a first one or more cells of a first TA and/or a second one or more cells of a second TA. In this case, the network node 110 may receive, from the core node 170, information identifying a set of cells in which to transmit an LP-WUS (e.g., rather than receiving an indication of a TA, and determining to transmit the LP-WUS in all cells of the TA). Nevertheless, the core node 170 may select, as the set of cells in which the network node 110 is to transmit the LP-WUS, all (or some) cells of only a single TA. In some aspects, the network node 110 may be configured for LP-WUS transmission in a single cell. For example, as a fallback case (e.g., when SFN-type transmission is not possible, when a UE 120 is determined to be near a center of a cell, when a coverage area includes only a single cell, etc.), the core node 170 may configure a single cell for transmission of the LP-WUS. As described above, in such a case, the core node 170 may use the same signaling, described herein, as for multi-cell SFN-type transmission (e.g., an information element that is configured to convey an indication of a set of cells, but that actually conveys an indication of only a single cell).

In some aspects, the core node 170 may determine a set of parameters for SFN-type transmission of an LP-WUS. For example, the core node 170 may determine (and identify to the network node 110 and/or the UE 120) a frequency for monitoring the SFN-type transmission of the LP-WUS. Additionally, or alternatively, the core node 170 may determine a resource configuration (e.g., a set of time resources, such as a periodicity or start offset, or frequency resources), a modulation configuration (e.g., a binary sequence for OOK modulation of an OOK LP-WUS), a multiplexing configuration (e.g., an orthogonal frequency division multiplexing (OFDM) sequence for an OFDM LP-WUS), or a signal configuration (e.g., a subcarrier spacing (SCS), a duration in OFDM symbols, or a set of physical resource blocks (PRB)).

In some aspects, such as when paging cycle or paging occasion configurations are different for different cells, the core node 170 may configure a periodicity for SFN-type LP-WUS transmission in connection with a paging cycle or paging occasion configuration. For example, the core node 170 may configure a default periodicity as the same as a smallest paging cycle value for a cell in which SFN-type LP-WUS is to occur. Additionally, or alternatively, the core node 170 may configure the periodicity as a multiple of the smallest paging cycle value or a minimum paging cycle value. In some aspects, the network node 110 (and/or other network nodes 110 within a common TA) may report one or more paging configurations of one or more cells (e.g., within the common TA), and the core node 170 may configure the periodicity based on the one or more paging configurations.

In some aspects, the core node 170 may configure cell muting on one or more cells. For example, the core node 170 may determine to mute one or more cells in a TA. For example, when the core node 170 indicates a TA in which the network node 110 is to transmit the SFN-type LP-WUS in all cells, the core node 170 may also indicate one or more muted cells in the TA. In this case, the network node 110 may forgo transmission of the SFN-type LP-WUS in the one or more muted cells of the TA. Additionally, or alternatively, when the core node 170 identifies a group of cells in which to transmit the SFN-type LP-WUS (e.g., across TAs, as described above), the group of cells may be selected to avoid any cells selected for cell muting. In these examples, the core node 170 may identify or select one or more cells for cell muting to avoid interference, reduce transmit power, or reallocate communication resources, among other examples.

In some aspects, the core node 170 may transmit information identifying a configuration for the SFN-type transmission of the LP-WUS. For example, the core node 170 may provide information identifying the configuration to each network node 110 associated with a cell in which an LP-WUS is to be transmitted. In some aspects, the core node 170 may transmit a request for SFN-type LP-WUS transmission to the network node 110 to trigger paging to the UE 120. For example, when the core node 170 provides a paging request to the network node 110, the paging request may include information identifying a configuration for an SFN LP-WUS transmission. In some aspects, the core node 170 may configure and/or determine a mapping for a UE subgroup. For example, the core node 170 may determine a mapping of UE identifiers (e.g., international mobile subscriber identity (IMSI) values) to subgroup identifiers. In this case, the core node 170 may indicate a subgroup identifier, mapped to an IMSI of the UE 120, to the network node 110. In this case, the core node 170 may provide the indication of the subgroup identifier with the information identifying the configuration for SFN-type LP-WUS transmission and to trigger transmission to the UE 120.

In some aspects, the UE 120 may receive configuration information (e.g., information identifying a configuration for SFN-type LP-WUS transmission monitoring) via system information. For example, the UE 120 may receive a system information block (SIB) (or master information block (MIB) or another information block) conveying configuration information. Additionally, or alternatively, the UE 120 may receive configuration information in a registration message. For example, when the UE 120 obtains or updates a registration area configuration, the UE 120 may receive a registration accept message conveying the configuration information for SFN-type LP-WUS transmission monitoring. In some aspects, the UE 120 may receive configuration information for a plurality of types of LP-WUSs. For example, the UE 120 may receive first configuration information (e.g., first time and frequency information) for monitoring of SFN-type LP-WUS transmissions and second configuration information (e.g., second time and frequency information) for monitoring of non-SFN-type LP-WUS transmissions.

As further shown in FIG. 5A, and by reference number 520, the UE 120 may receive an LP-WUS. For example, the UE 120 may receive the LP-WUS using the LP-WUR 310. In some aspects, the LP-WUS may be an SFN transmission. For example, the network node 110 (or a set of network nodes 110) may transmit a set of SFN transmissions to convey the LP-WUS in a set of cells. In this case, the UE 120 may receive one or more of the set of SFN transmissions. For example, the UE 120 may receive a single SFN transmission and may detect the LP-WUS based on the single SFN transmission. Additionally, or alternatively, a plurality of SFN transmissions may interfere with each other resulting in a gain to the LP-WUS (in other words, constructive interference), and the UE 120 may detect a result of the plurality of SFN transmissions interfering with each other (in other words, a combined signal).

In some aspects, the network node 110 may transmit the LP-WUS with a configured transmit power. For example, the network node 110 may transmit an SFN-type LP-WUS transmission with a reduced power relative to another type of transmission (e.g., a non-SFN-type LP-WUS transmission or an SSB transmission). In this case, combination gain from transmissions of the LP-WUS in the same time and frequency resources across a plurality of cells can result in successful detection of the LP-WUS by the UE 120 (e.g., at cell edges) even with reduced transmit power from any one transmitter. In other words, combination gain from a plurality of transmissions may result in at least a threshold received power at the UE 120 with reduced transmit power at any one network node 110, thereby providing energy saving to the network node(s) 110.

In some aspects, the network node 110 (or a group of network nodes 110) may transmit one or more SFN-type transmissions of the LP-WUS in a set of cells of a tracking area. For example, with respect to a first tracking area “TA-1”, which is included in a registration area of a first set of UEs, a network node 110 may transmit an LP-WUS to any of the first set of UEs by transmitting LP-WUS transmissions in a first set of cells of the first tracking area. Similarly, with respect to another tracking area “TA-2”, which is included in a registration area of a second set of UEs (e.g., which may or may not at least partially overlap with the first set of UEs), the network node 110 may transmit an LP-WUS to any of the second set of UEs by transmitting LP-WUS transmissions in a second set of cells (e.g., which may or may not at least partially overlap with the first set of cells) of the second tracking area. Accordingly, the UE 120 may be configured with TA-specific resources (e.g., time or frequency resources) for SFN-type LP-WUS reception and may obtain a configuration of a new set of TA-specific resources when the UE 120 changes TAs.

In some aspects, such as when SFN-type LP-WUS transmission occasions do not have a one-to-one mapping to paging occasions, there may be a mapping rule specified for the UE 120 (e.g., by the core node 170 or statically specified). For example, the network node 110 and/or the UE 120 may be configured with a mapping rule when respective periodicities of SFN-type LP-WUS occasions and paging occasions are different. Accordingly, an LP-WUS may wake up a main radio 305 of the UE 120 to cause the UE 120 to monitor a paging PDCCH in a next paging occasion, even when there is an LP-WUS occasion occurring in between he LP-WUS and the next paging occasion. For example, as shown in FIG. 5B, a first cell “Cell-A” is associated with a first periodicity 580 for SFN-type LP-WUS transmission and a second periodicity 582 for paging occasions. As shown, when the UE 120 detects an LP-WUS 590 on cell-A, the UE 120 is configured to monitor a next paging occasion 592, even though there is an intervening LP-WUS occasion 594 occurring between the LP-WUS 590 and the paging occasion 592. In contrast, a second cell “Cell-B” is associated with the first periodicity 580 for SFN-type LP-WUS transmission and a third periodicity 584 for paging occasions. On Cell-B, when the UE 120 detects an LP-WUS transmission 596, the UE 120 monitors the next paging occasion 598 without any intervening LP-WUS transmission occasions.

As further shown in FIG. 5A, and by reference number 530, the UE 120 may change power states. For example, based on detecting the LP-WUS using the LP-WUR 310, the UE 120 may activate the main radio 305 for communication. Additionally, or alternatively, the UE 120 may transition between a set of states, such as from an inactive state (or idle mode) to an active state (or active mode). As shown by reference number 540, the UE 120 may communicate using the main radio 305. For example, the UE 120 may monitor a paging occasion to receive a PDCCH communication using the main radio 305.

As indicated above, FIGS. 5A-5B are provided as an example. Other examples may differ from what is described with respect to FIGS. 5A-5B.

FIG. 6 is a diagram illustrating an example process 600 performed, for example, at a UE or an apparatus of a UE, in accordance with the present disclosure. Example process 600 is an example where the apparatus or the UE (e.g., UE 120) performs operations associated with SFN transmission.

As shown in FIG. 6, in some aspects, process 600 may include receiving, using a first Tx/Rx chain, an LP-WUS communication, wherein the LP-WUS communication is conveyed via a set of SFN-type transmissions from a set of transmitters associated with a set of cells (block 610). For example, the UE (e.g., using reception component 902 and/or communication manager 906, depicted in FIG. 9) may receive, using a first Tx/Rx chain, an LP-WUS communication, wherein the LP-WUS communication is conveyed via a set of SFN-type transmissions from a set of transmitters associated with a set of cells, as described above.

As further shown in FIG. 6, in some aspects, process 600 may include communicating, using a second Tx/Rx chain, in one or more resources in connection with the LP-WUS (block 620). For example, the UE (e.g., using reception component 902, transmission component 904, and/or communication manager 906, depicted in FIG. 9) may communicate, using a second Tx/Rx chain, in one or more resources in connection with the LP-WUS, as described above.

Process 600 may include additional aspects, such as any single aspect or any combination of aspects described below and/or in connection with one or more other processes described elsewhere herein.

In a first aspect, the set of SFN-type transmissions is associated with a common waveform and a common signal content.

In a second aspect, alone or in combination with the first aspect, the set of cells is associated with a common tracking area identified by a common tracking area code.

In a third aspect, alone or in combination with one or more of the first and second aspects, the LP-WUS communication includes an indication for monitoring of a paging message and is directed to a registration area of the UE, wherein the registration area is associated with at least one tracking area corresponding to the set of cells.

In a fourth aspect, alone or in combination with one or more of the first through third aspects, the set of cells is associated with a configured LP-WUS cell group.

In a fifth aspect, alone or in combination with one or more of the first through fourth aspects, a first cell, of the set of cells, is associated with a first tracking area, and a second cell, of the set of cells, is associated with a second tracking area.

In a sixth aspect, alone or in combination with one or more of the first through fifth aspects, a configuration of the LP-WUS communication includes a configuration of one or more parameters, wherein the one or more parameters includes a monitoring frequency for the LP-WUS communication, an SFN type for the LP-WUS communication, a binary modulation sequence for the LP-WUS communication, an orthogonal frequency division multiplexing sequence for the LP-WUS communication, a subcarrier spacing for the LP-WUS communication, a duration for the LP-WUS communication, or a quantity of physical resource blocks allocated for the LP-WUS communication.

In a seventh aspect, alone or in combination with one or more of the first through sixth aspects, the configuration is specific to the SFN type for the LP-WUS communication.

In an eighth aspect, alone or in combination with one or more of the first through seventh aspects, the LP-WUS communication is associated with a mapping rule for mapping an LP-WUS occasion to a paging occasion.

In a ninth aspect, alone or in combination with one or more of the first through eighth aspects, process 600 includes receiving configuration information associated with indicating a resource for the LP-WUS communication, wherein the configuration information is conveyed in at least one of a system information message, or a registration area configuration message.

In a tenth aspect, alone or in combination with one or more of the first through ninth aspects, the configuration information includes a first configuration for the LP-WUS communication and second configuration for another type of LP-WUS communication.

In an eleventh aspect, alone or in combination with one or more of the first through tenth aspects, the set of cells includes a single cell.

In a twelfth aspect, alone or in combination with one or more of the first through eleventh aspects, the set of cells includes a plurality of cells.

In a thirteenth aspect, alone or in combination with one or more of the first through twelfth aspects, process 600 includes receiving, in connection with the LP-WUS communication, an SFN low power synchronization signal.

In a fourteenth aspect, alone or in combination with one or more of the first through thirteenth aspects, a first transmit power associated with the LP-WUS communication is less than a second transmit power associated with a synchronization signal block on at least one cell of the set of cells.

In a fifteenth aspect, alone or in combination with one or more of the first through fourteenth aspects, the LP-WUS communication is received in a first part of a cell, of the set of cells, and wherein a second part of the cell is subject to cell muting.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a network node or an apparatus of a network node, in accordance with the present disclosure.

Example process 700 is an example where the apparatus or the network node (e.g., network node 110) performs operations associated with SFN transmission.

As shown in FIG. 7, in some aspects, process 700 may include transmitting a transmission of an LP-WUS communication, wherein the transmission of the LP-WUS communication is conveyed via a SFN-type transmission, of a set of SFN-type transmissions, and wherein the transmission of the LP-WUS is coordinated with a set of transmitters associated with a set of cells (block 710). For example, the network node (e.g., using transmission component 1004 and/or communication manager 1006, depicted in FIG. 10) may transmit a transmission of an LP-WUS communication, wherein the transmission of the LP-WUS communication is conveyed via a SFN-type transmission, of a set of SFN-type transmissions, and wherein the transmission of the LP-WUS is coordinated with a set of transmitters associated with a set of cells, as described above.

As further shown in FIG. 7, in some aspects, process 700 may include communicating in one or more resources in connection with the LP-WUS (block 720). For example, the network node (e.g., using reception component 1002, transmission component 1004, and/or communication manager 1006, depicted in FIG. 10) may communicate in one or more resources in connection with the LP-WUS, as described above.

Process 700 may include additional aspects, such as any single aspect or any combination of aspects described below and/or in connection with one or more other processes described elsewhere herein.

In a first aspect, the set of SFN-type transmissions is associated with a common waveform and a common signal content.

In a second aspect, alone or in combination with the first aspect, the set of cells is associated with a common tracking area identified by a common tracking area code.

In a third aspect, alone or in combination with one or more of the first and second aspects, the LP-WUS communication includes an indication for monitoring of a paging message and is directed to a registration area of the UE, wherein the registration area is associated with at least one tracking area corresponding to the set of cells.

In a fourth aspect, alone or in combination with one or more of the first through third aspects, the set of cells is associated with a configured LP-WUS cell group.

In a fifth aspect, alone or in combination with one or more of the first through fourth aspects, a first cell, of the set of cells, is associated with a first tracking area, and a second cell, of the set of cells, is associated with a second tracking area.

In a sixth aspect, alone or in combination with one or more of the first through fifth aspects, a configuration of the LP-WUS communication includes a configuration of one or more parameters, wherein the one or more parameters includes a monitoring frequency for the LP-WUS communication, an SFN type for the LP-WUS communication, a binary modulation sequence for the LP-WUS communication, an orthogonal frequency division multiplexing sequence for the LP-WUS communication, a subcarrier spacing for the LP-WUS communication, a duration for the LP-WUS communication, or a quantity of physical resource blocks allocated for the LP-WUS communication.

In a seventh aspect, alone or in combination with one or more of the first through sixth aspects, the configuration is specific to the SFN type for the LP-WUS communication.

In an eighth aspect, alone or in combination with one or more of the first through seventh aspects, the LP-WUS communication is associated with a mapping rule for mapping an LP-WUS occasion to a paging occasion.

In a ninth aspect, alone or in combination with one or more of the first through eighth aspects, process 700 includes transmitting configuration information associated with indicating a resource for the LP-WUS communication, wherein the configuration information is conveyed in at least one of a system information message, or a registration area configuration message.

In a tenth aspect, alone or in combination with one or more of the first through ninth aspects, the configuration information includes a first configuration for the LP-WUS communication and second configuration for another type of LP-WUS communication.

In an eleventh aspect, alone or in combination with one or more of the first through tenth aspects, the set of cells includes a single cell.

In a twelfth aspect, alone or in combination with one or more of the first through eleventh aspects, the set of cells includes a plurality of cells.

In a thirteenth aspect, alone or in combination with one or more of the first through twelfth aspects, process 700 includes transmitting, in connection with the LP-WUS communication, an SFN low power synchronization signal.

In a fourteenth aspect, alone or in combination with one or more of the first through thirteenth aspects, a first transmit power associated with the LP-WUS communication is less than a second transmit power associated with a synchronization signal block on at least one cell of the set of cells.

In a fifteenth aspect, alone or in combination with one or more of the first through fourteenth aspects, the LP-WUS communication is transmitted in a first part of a cell, of the set of cells, and wherein a second part of the cell is subject to cell muting.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a core node or an apparatus of a core node, in accordance with the present disclosure. Example process 800 is an example where the apparatus or the core node (e.g., core node 170) performs operations associated with SFN transmission.

As shown in FIG. 8, in some aspects, process 800 may include identifying a configuration for a set of cells for transmission of an LP-WUS communication, wherein transmission of the LP-WUS communication is conveyed via a set of SFN-type transmissions from a set of transmitters and in a set of cells (block 810). For example, the core node (e.g., using communication manager 1106, depicted in FIG. 11) may identify a configuration for a set of cells for transmission of an LP-WUS communication, wherein transmission of the LP-WUS communication is conveyed via a set of SFN-type transmissions from a set of transmitters and in a set of cells, as described above.

As further shown in FIG. 8, in some aspects, process 800 may include sending, to a set of network nodes associated with the set of transmitters, information identifying the configuration to cause the transmission of the LP-WUS communication via the set of SFN-type transmissions in the set of cells (block 820). For example, the core node (e.g., using communication manager 1106, depicted in FIG. 11) may send, to a set of network nodes associated with the set of transmitters, information identifying the configuration to cause the transmission of the LP-WUS communication via the set of SFN-type transmissions in the set of cells, as described above.

Process 800 may include additional aspects, such as any single aspect or any combination of aspects described below and/or in connection with one or more other processes described elsewhere herein.

In a first aspect, the set of SFN-type transmissions is associated with a common waveform and a common signal content.

In a second aspect, alone or in combination with the first aspect, the set of cells is associated with a common tracking area identified by a common tracking area code.

In a third aspect, alone or in combination with one or more of the first and second aspects, the LP-WUS communication is configured to include an indication for monitoring of a paging message and is directed to a registration area of a user equipment, wherein the registration area is associated with at least one tracking area corresponding to the set of cells.

In a fourth aspect, alone or in combination with one or more of the first through third aspects, the set of cells is associated with a configured LP-WUS cell group.

In a fifth aspect, alone or in combination with one or more of the first through fourth aspects, a first cell, of the set of cells, is associated with a first tracking area, and a second cell, of the set of cells, is associated with a second tracking area.

In a sixth aspect, alone or in combination with one or more of the first through fifth aspects, the configuration includes at least one of a monitoring frequency for the LP-WUS communication, an SFN type for the LP-WUS communication, a binary modulation sequence for the LP-WUS communication, an orthogonal frequency division multiplexing sequence for the LP-WUS communication, a subcarrier spacing for the LP-WUS communication, a duration for the LP-WUS communication, or a quantity of physical resource blocks allocated for the LP-WUS communication.

In a seventh aspect, alone or in combination with one or more of the first through sixth aspects, the configuration is specific to the SFN type for the LP-WUS communication.

In an eighth aspect, alone or in combination with one or more of the first through seventh aspects, the LP-WUS communication is associated with a mapping rule for mapping an LP-WUS occasion to a paging occasion.

In a ninth aspect, alone or in combination with one or more of the first through eighth aspects, the set of cells includes a single cell.

In a tenth aspect, alone or in combination with one or more of the first through ninth aspects, the set of cells includes a plurality of cells.

In an eleventh aspect, alone or in combination with one or more of the first through tenth aspects, the LP-WUS communication is configured to be transmitted in a first part of a cell, of the set of cells, and wherein a second part of the cell is configured to be subject to cell muting.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 140 described in connection with FIG. 1) of the UE.

In some aspects, the apparatus 900 may be configured to perform one or more operations described herein in connection with FIGS. 5A-5B. Additionally, or alternatively, the apparatus 900 may be configured to perform one or more processes described herein, such as process 600 of FIG. 6. In some aspects, the apparatus 900 and/or one or more components shown in FIG. 9 may include one or more components of the UE described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the UE described above in connection with FIG. 1, such as a radio, one or more RF chains, one or more transceivers, or one or more modems, each of which may in turn be coupled with one or more antennas of the UE.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 904 may be co-located with the reception component 902.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive, using a first Tx/Rx chain, an LP-WUS communication, wherein the LP-WUS communication is conveyed via a set of SFN-type transmissions from a set of transmitters associated with a set of cells. The reception component 902 and/or the transmission component 904 may communicate, using a second Tx/Rx chain, in one or more resources in connection with the LP-WUS. The reception component 902 may receive configuration information associated with indicating a resource for the LP-WUS communication wherein the configuration information is conveyed in at least one of: a system information message, or a registration area configuration message. The reception component 902 may receive, in connection with the LP-WUS communication, an SFN low power synchronization signal.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network node, or a network node may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 155 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 145 described in connection with FIG. 1) of the network node.

In some aspects, the apparatus 1000 may be configured to perform one or more operations described herein in connection with FIGS. 5A-5B. Additionally, or alternatively, the apparatus 1000 may be configured to perform one or more processes described herein, such as process 700 of FIG. 7. In some aspects, the apparatus 1000 and/or one or more components shown in FIG. 10 may include one or more components of the network node described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the network node described above in connection with FIG. 1, such as a radio, one or more RF chains, one or more transceivers, or one or more modems, each of which may in turn be coupled with one or more antennas of the network node. In some aspects, the reception component 1002 and/or the transmission component 1004 may include or may be included in a network interface. The network interface may be configured to obtain and/or output signals for the apparatus 1000 via one or more communications links, such as a backhaul link, a midhaul link, and/or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1004 may be co-located with the reception component 1002.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The transmission component 1004 may transmit a transmission of an LP-WUS communication, wherein the transmission of the LP-WUS communication is conveyed via a SFN-type transmission, of a set of SFN-type transmissions, and wherein the transmission of the LP-WUS is coordinated with a set of transmitters associated with a set of cells. The reception component 1002 and/or the transmission component 1004 may communicate in one or more resources in connection with the LP-WUS. The transmission component 1004 may transmit configuration information associated with indicating a resource for the LP-WUS communication wherein the configuration information is conveyed in at least one of: a system information message, or a registration area configuration message. The transmission component 1004 may transmit, in connection with the LP-WUS communication, an SFN low power synchronization signal.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a core node, or a core node may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 174 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 172 described in connection with FIG. 1) of the core node.

In some aspects, the apparatus 1100 may be configured to perform one or more operations described herein in connection with FIGS. 5A-5B. Additionally, or alternatively, the apparatus 1100 may be configured to perform one or more processes described herein, such as process 800 of FIG. 8. In some aspects, the apparatus 1100 and/or one or more components shown in FIG. 11 may include one or more components of the core node described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the core node described above in connection with FIG. 1, such as a radio, one or more RF chains, one or more transceivers, or one or more modems, each of which may in turn be coupled with one or more antennas of the core node.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the core node described above in connection with FIG. 1, such as a radio, one or more RF chains, one or more transceivers, or one or more modems, each of which may in turn be coupled with one or more antennas of the core node described in connection with FIG. 1. In some aspects, the transmission component 1104 may be co-located with the reception component 1102.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The communication manager 1106 may identify a configuration for a set of cells for transmission of an LP-WUS communication, wherein transmission of the LP-WUS communication is conveyed via a set of SFN-type transmissions from a set of transmitters and in a set of cells. The communication manager 1106 may send, to a set of network nodes associated with the set of transmitters, information identifying the configuration to cause the transmission of the LP-WUS communication via the set of SFN-type transmissions in the set of cells.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving, using a first Tx/Rx chain, a low-power wake-up signal (LP-WUS) communication, wherein the LP-WUS communication is conveyed via a set of single frequency network (SFN)-type transmissions from a set of transmitters associated with a set of cells; and communicating, using a second Tx/Rx chain, in one or more resources in connection with the LP-WUS.

Aspect 2: The method of Aspect 1, wherein the set of SFN-type transmissions is associated with a common waveform and a common signal content.

Aspect 3: The method of any of Aspects 1-2, wherein the set of cells is associated with a common tracking area identified by a common tracking area code.

Aspect 4: The method of any of Aspects 1-3, wherein the LP-WUS communication includes an indication for monitoring of a paging message and is directed to a registration area of the UE, wherein the registration area is associated with at least one tracking area corresponding to the set of cells.

Aspect 5: The method of any of Aspects 1-4, wherein the set of cells is associated with a configured LP-WUS cell group.

Aspect 6: The method of Aspect 5, wherein a first cell, of the set of cells, is associated with a first tracking area, and a second cell, of the set of cells, is associated with a second tracking area.

Aspect 7: The method of any of Aspects 1-6, wherein a configuration of the LP-WUS communication includes a configuration of one or more parameters, wherein the one or more parameters includes: a monitoring frequency for the LP-WUS communication, an SFN type for the LP-WUS communication, a binary modulation sequence for the LP-WUS communication, an orthogonal frequency division multiplexing sequence for the LP-WUS communication, a subcarrier spacing for the LP-WUS communication, a duration for the LP-WUS communication, or a quantity of physical resource blocks allocated for the LP-WUS communication.

Aspect 8: The method of Aspect 7, wherein the configuration is specific to the SFN type for the LP-WUS communication.

Aspect 9: The method of Aspect 7, the configuration is associated with a registration area of the UE.

Aspect 10: The method of any of Aspects 1-9, wherein the LP-WUS communication is associated with a mapping rule for mapping an LP-WUS occasion to a paging occasion.

Aspect 11: The method of any of Aspects 1-10, further comprising: receiving configuration information associated with indicating a resource for the LP-WUS communication, wherein the configuration information is conveyed in at least one of: a system information message, or a registration area configuration message.

Aspect 12: The method of Aspect 11, wherein the configuration information includes a first configuration for the LP-WUS communication and second configuration for another type of LP-WUS communication.

Aspect 13: The method of any of Aspects 1-12, wherein the set of cells includes a single cell.

Aspect 14: The method of any of Aspects 1-13, wherein the set of cells includes a plurality of cells.

Aspect 15: The method of any of Aspects 1-14, further comprising: receiving, in connection with the LP-WUS communication, an SFN low power synchronization signal.

Aspect 16: The method of any of Aspects 1-15, wherein a first transmit power associated with the LP-WUS communication is less than a second transmit power associated with a synchronization signal block on at least one cell of the set of cells.

Aspect 17: The method of any of Aspects 1-16, wherein the LP-WUS communication is received in a first part of a cell, of the set of cells, and wherein a second part of the cell is subject to cell muting.

Aspect 18: A method of wireless communication performed by a network node, comprising: transmitting a transmission of a low-power wake-up signal (LP-WUS) communication, wherein the transmission of the LP-WUS communication is conveyed via a single frequency network (SFN)-type transmission, of a set of SFN-type transmissions, and wherein the transmission of the LP-WUS is coordinated with a set of transmitters associated with a set of cells; and communicating in one or more resources in connection with the LP-WUS.

Aspect 19: The method of Aspect 18, wherein the set of SFN-type transmissions is associated with a common waveform and a common signal content.

Aspect 20: The method of any of Aspects 18-19, wherein the set of cells is associated with a common tracking area identified by a common tracking area code.

Aspect 21: The method of any of Aspects 18-20, wherein the LP-WUS communication includes an indication for monitoring of a paging message and is directed to a registration area of the UE, wherein the registration area is associated with at least one tracking area corresponding to the set of cells.

Aspect 22: The method of any of Aspects 18-21, wherein the set of cells is associated with a configured LP-WUS cell group.

Aspect 23: The method of Aspect 22, wherein a first cell, of the set of cells, is associated with a first tracking area, and a second cell, of the set of cells, is associated with a second tracking area.

Aspect 24: The method of any of Aspects 18-23, wherein a configuration of the LP-WUS communication includes a configuration of one or more parameters, wherein the one or more parameters includes: a monitoring frequency for the LP-WUS communication, an SFN type for the LP-WUS communication, a binary modulation sequence for the LP-WUS communication, an orthogonal frequency division multiplexing sequence for the LP-WUS communication, a subcarrier spacing for the LP-WUS communication, a duration for the LP-WUS communication, or a quantity of physical resource blocks allocated for the LP-WUS communication.

Aspect 25: The method of Aspect 24, wherein the configuration is specific to the SFN type for the LP-WUS communication.

Aspect 26: The method of Aspect 24, the configuration is associated with a registration area of a user equipment.

Aspect 27: The method of any of Aspects 18-26, wherein the LP-WUS communication is associated with a mapping rule for mapping an LP-WUS occasion to a paging occasion.

Aspect 28: The method of any of Aspects 18-27, further comprising: transmitting configuration information associated with indicating a resource for the LP-WUS communication, wherein the configuration information is conveyed in at least one of: a system information message, or a registration area configuration message.

Aspect 29: The method of Aspect 28, wherein the configuration information includes a first configuration for the LP-WUS communication and second configuration for another type of LP-WUS communication.

Aspect 30: The method of any of Aspects 18-29, wherein the set of cells includes a single cell.

Aspect 31: The method of any of Aspects 18-30, wherein the set of cells includes a plurality of cells.

Aspect 32: The method of any of Aspects 18-31, further comprising: transmitting, in connection with the LP-WUS communication, an SFN low power synchronization signal.

Aspect 33: The method of any of Aspects 18-32, wherein a first transmit power associated with the LP-WUS communication is less than a second transmit power associated with a synchronization signal block on at least one cell of the set of cells.

Aspect 34: The method of any of Aspects 18-33, wherein the LP-WUS communication is transmitted in a first part of a cell, of the set of cells, and wherein a second part of the cell is subject to cell muting.

Aspect 35: A method of wireless communication performed by a core node, comprising: identifying a configuration for a set of cells for transmission of a low-power wake-up signal (LP-WUS) communication, wherein transmission of the LP-WUS communication is conveyed via a set of single frequency network (SFN)-type transmissions from a set of transmitters and in a set of cells; and sending, to a set of network nodes associated with the set of transmitters, information identifying the configuration to cause the transmission of the LP-WUS communication via the set of SFN-type transmissions in the set of cells.

Aspect 36: The method of Aspect 35, wherein the set of SFN-type transmissions is associated with a common waveform and a common signal content.

Aspect 37: The method of any of Aspects 35-36, wherein the set of cells is associated with a common tracking area identified by a common tracking area code.

Aspect 38: The method of any of Aspects 35-37, wherein the LP-WUS communication is configured to include an indication for monitoring of a paging message and is directed to a registration area of a user equipment, wherein the registration area is associated with at least one tracking area corresponding to the set of cells.

Aspect 39: The method of any of Aspects 35-38, wherein the set of cells is associated with a configured LP-WUS cell group.

Aspect 40: The method of Aspect 39, wherein a first cell, of the set of cells, is associated with a first tracking area, and a second cell, of the set of cells, is associated with a second tracking area.

Aspect 41: The method of any of Aspects 35-40, wherein the configuration includes at least one of: a monitoring frequency for the LP-WUS communication, an SFN type for the LP-WUS communication, a binary modulation sequence for the LP-WUS communication, an orthogonal frequency division multiplexing sequence for the LP-WUS communication, a subcarrier spacing for the LP-WUS communication, a duration for the LP-WUS communication, or a quantity of physical resource blocks allocated for the LP-WUS communication.

Aspect 42: The method of Aspect 41, wherein the configuration is specific to the SFN type for the LP-WUS communication.

Aspect 43: The method of Aspect 41, the configuration is associated with a registration area of a user equipment.

Aspect 44: The method of any of Aspects 35-43, wherein the LP-WUS communication is associated with a mapping rule for mapping an LP-WUS occasion to a paging occasion.

Aspect 45: The method of any of Aspects 35-44, wherein the set of cells includes a single cell.

Aspect 46: The method of any of Aspects 35-45, wherein the set of cells includes a plurality of cells.

Aspect 47: The method of any of Aspects 35-46, wherein the LP-WUS communication is configured to be transmitted in a first part of a cell, of the set of cells, and wherein a second part of the cell is configured to be subject to cell muting.

Aspect 48: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-47.

Aspect 49: An apparatus for wireless communication at a device, the apparatus comprising one or more memories and one or more processors coupled to the one or more memories, the one or more processors configured to cause the device to perform the method of one or more of Aspects 1-47.

Aspect 50: An apparatus for wireless communication, the apparatus comprising at least one means for performing the method of one or more of Aspects 1-47.

Aspect 51: A non-transitory computer-readable medium storing code for wireless communication, the code comprising instructions executable by one or more processors to perform the method of one or more of Aspects 1-47.

Aspect 52: A non-transitory computer-readable medium storing a set of instructions for wireless communication, the set of instructions comprising one or more instructions that, when executed by one or more processors of a device, cause the device to perform the method of one or more of Aspects 1-47.

Aspect 53: A device for wireless communication, the device comprising a processing system that includes one or more processors and one or more memories coupled with the one or more processors, the processing system configured to cause the device to perform the method of one or more of Aspects 1-47.

Aspect 54: An apparatus for wireless communication at a device, the apparatus comprising one or more memories and one or more processors coupled to the one or more memories, the one or more processors individually or collectively configured to cause the device to perform the method of one or more of Aspects 1-47.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more. ” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
receive, using a first transmit/receive (Tx/Rx) chain, a low-power wake-up signal (LP-WUS) communication, wherein the LP-WUS communication is conveyed via a set of single frequency network (SFN)-type transmissions from a set of transmitters associated with a set of cells; and
communicate, using a second Tx/Rx chain, in one or more resources in connection with the LP-WUS.

2. The UE of claim 1, wherein the set of SFN-type transmissions is associated with a common waveform and a common signal content.

3. The UE of claim 1, wherein the set of cells is associated with a common tracking area identified by a common tracking area code.

4. The UE of claim 1, wherein the LP-WUS communication includes an indication for monitoring of a paging message and is directed to a registration area of the UE, wherein the registration area is associated with at least one tracking area corresponding to the set of cells.

5. The UE of claim 1, wherein the set of cells is associated with a configured LP-WUS cell group.

6. The UE of claim 5, wherein a first cell, of the set of cells, is associated with a first tracking area, and a second cell, of the set of cells, is associated with a second tracking area.

7. The UE of claim 1, wherein a configuration of the LP-WUS communication includes a configuration of one or more parameters, wherein the one or more parameters includes:
a monitoring frequency for the LP-WUS communication,
an SFN type for the LP-WUS communication,
a binary modulation sequence for the LP-WUS communication,
an orthogonal frequency division multiplexing sequence for the LP-WUS communication,
a subcarrier spacing for the LP-WUS communication,
a duration for the LP-WUS communication, or
a quantity of physical resource blocks allocated for the LP-WUS communication.

8. The UE of claim 7, wherein the configuration is specific to the SFN type for the LP-WUS communication.

9. The UE of claim 7, the configuration is associated with a registration area of the UE.

10. The UE of claim 1, wherein the LP-WUS communication is associated with a mapping rule for mapping an LP-WUS occasion to a paging occasion.

11. The UE of claim 1, wherein the one or more processors are further configured to cause the UE to:
receive configuration information associated with indicating a resource for the LP-WUS communication,
wherein the configuration information is conveyed in at least one of: a system information message, or a registration area configuration message.

12. The UE of claim 11, wherein the configuration information includes a first configuration for the LP-WUS communication and second configuration for another type of LP-WUS communication.

13. The UE of claim 1, wherein the set of cells includes a single cell.

14. The UE of claim 1, wherein the set of cells includes a plurality of cells.

15. A network node for wireless communication, comprising:
one or more memories; and
one or more processors, coupled to the one or more memories, configured to cause the network node to:
transmit a transmission of a low-power wake-up signal (LP-WUS) communication, wherein the transmission of the LP-WUS communication is conveyed via a single frequency network (SFN)-type transmission, of a set of SFN-type transmissions, and wherein the transmission of the LP-WUS is coordinated with a set of transmitters associated with a set of cells; and
communicate in one or more resources in connection with the LP-WUS.

16. The network node of claim 15, wherein the set of SFN-type transmissions is associated with a common waveform and a common signal content.

17. The network node of claim 15, wherein the set of cells is associated with a common tracking area identified by a common tracking area code.

18. The network node of claim 15, wherein the LP-WUS communication includes an indication for monitoring of a paging message and is directed to a registration area of a user equipment, wherein the registration area is associated with at least one tracking area corresponding to the set of cells.

19. The network node of claim 15, wherein the set of cells is associated with a configured LP-WUS cell group.

20. The network node of claim 19, wherein a first cell, of the set of cells, is associated with a first tracking area, and a second cell, of the set of cells, is associated with a second tracking area.

21. The network node of claim 15, wherein a configuration of the LP-WUS communication includes a configuration of one or more parameters, wherein the one or more parameters includes:
a monitoring frequency for the LP-WUS communication,
an SFN type for the LP-WUS communication,
a binary modulation sequence for the LP-WUS communication,
an orthogonal frequency division multiplexing sequence for the LP-WUS communication,
a subcarrier spacing for the LP-WUS communication,
a duration for the LP-WUS communication, or
a quantity of physical resource blocks allocated for the LP-WUS communication.

22. The network node of claim 15, wherein the LP-WUS communication is associated with a mapping rule for mapping an LP-WUS occasion to a paging occasion.

23. The network node of claim 15, wherein the one or more processors are further configured to cause the network node to:
transmit configuration information associated with indicating a resource for the LP-WUS communication,
wherein the configuration information is conveyed in at least one of: a system information message, or a registration area configuration message.

24. A core node for wireless communication, comprising:
one or more memories; and
one or more processors, coupled to the one or more memories, configured to cause the core node to:
identify a configuration for a set of cells for transmission of a low-power wake-up signal (LP-WUS) communication, wherein transmission of the LP-WUS communication is conveyed via a set of single frequency network (SFN)-type transmissions from a set of transmitters and in a set of cells; and
send, to a set of network nodes associated with the set of transmitters, information identifying the configuration to cause the transmission of the LP-WUS communication via the set of SFN-type transmissions in the set of cells.

25. The core node of claim 24, wherein the set of cells is associated with a common tracking area identified by a common tracking area code.

26. The core node of claim 24, wherein the set of cells is associated with a configured LP-WUS cell group.

27. The core node of claim 26, wherein a first cell, of the set of cells, is associated with a first tracking area, and a second cell, of the set of cells, is associated with a second tracking area.

28. The core node of claim 24, wherein the configuration includes at least one of:
a monitoring frequency for the LP-WUS communication,
an SFN type for the LP-WUS communication,
a binary modulation sequence for the LP-WUS communication,
an orthogonal frequency division multiplexing sequence for the LP-WUS communication,
a subcarrier spacing for the LP-WUS communication,
a duration for the LP-WUS communication, or
a quantity of physical resource blocks allocated for the LP-WUS communication.

29. The core node of claim 24, wherein the LP-WUS communication is configured to be transmitted in a first part of a cell, of the set of cells, and wherein a second part of the cell is configured to be subject to cell muting.

30. A method of wireless communication performed by a user equipment (UE), comprising:
receiving, using a first transmit/receive (Tx/Rx) chain, a low-power wake-up signal (LP-WUS) communication, wherein the LP-WUS communication is conveyed via a set of single frequency network (SFN)-type transmissions from a set of transmitters associated with a set of cells; and
communicating, using a second Tx/Rx chain, in one or more resources in connection with the LP-WUS.
